(19) United States
(12) Patent Application Publication
(10) Pub. No.: US 2025/0185630 A1
(43) Pub. Date: Jun. 12, 2025

(54) RETRACTABLE LEASH

(71) Applicant: Nite Ize, Inc., Boulder, CO (US)

(72) Inventors: Bowden ORMSBEE, Longmont, CO (US); Michael MOREHARDT, Erie, CO (US); Dale KARACOSTAS, Boulder, CO (US)

(73) Assignee: Nite Ize, Inc., Boulder, CO (US)

(21) Appl. No.: 18/971,316

(22) Filed: Dec. 6, 2024

Related U.S. Application Data
(63) Continuation-in-part of application No. 29/919,835, filed on Dec. 6, 2023.
(60) Provisional application No. 63/607,218, filed on Dec. 7, 2023.

(51) Int. Cl. A01K 27/00

(52) U.S. Cl. CPC A01K 27/004; A01K 27/001

(57) ABSTRACT

A restraint system for an animal comprising a collar assembly and a retractable leash assembly. The collar assembly comprises a strap member adapted to be secured around a portion of the animal and a pouch member secured to the strap member. The pouch member defines a pouch chamber and an open end. The retractable leash assembly comprises a retraction assembly secured to the strap member within the pouch chamber, a cord member operatively connected to the retraction assembly, and a handle member operatively connected to the cord member. The retractable leash assembly is operable in a retracted configuration in which the handle member is substantially within the pouch chamber. The retractable leash assembly is operable in an extended configuration in which the handle member is outside of the pouch chamber.

This application claims the benefit of U.S. Provisional Patent Application Ser. No. 63/607,218, filed Dec. 7, 2023, the entire disclosures of which are incorporated by reference herein.

This application is also a continuation-in-part of U.S. patent application Ser. No. 29/919,835, filed Dec. 6, 2023, the entire disclosures of which are incorporated by reference herein.

This application is also related to U.S. Pat. No. 8,474,414, entitled “Retractable Leash and Restraint Assembly,” the entire disclosure of which is incorporated by reference herein.

### FIELD OF THE INVENTION

Embodiments of the present invention relate generally to a retractable leash and animal restraint assembly. More particularly, embodiments of the present invention relate to a retractable leash and collar assembly.

### BACKGROUND OF THE INVENTION

Conventional animal restraining assemblies comprise collars and separate, detachable leashes. Frequently, these assemblies consist of multiple parts that must be assembled before use. This can become quite cumbersome when a user attempts to walk their pet and must carry the additional parts, such as the leash, in case necessary. Particularly in cases where a user chooses to utilize such assemblies during exercise, any additional components may make the practice altogether distasteful.

Even where integrated restraining devices exist, these devices are traditionally uncomfortable for the animal and cumbersome for the user, as they traditionally comprise bulky, heavy components. For example, the animal is forced to bear the burden instead of a user needing to carry the additional apparatus, as described above. Even where integrated assemblies exist, such devices traditionally lack the strength to fully restrain a large animal and the flexibility to enable a user to extract and retract the leash from the restraining component easily. Further, traditional integrated assemblies require separate pouches or components as part of the assembly, making the device's manufacture unnecessarily expensive.

A need, therefore, exists for a retractable leash and restraint assembly having a collar comprising a built-in leash that is not exposed to the elements, which minimizes excess equipment, is comfortable to the animal, is easy to use and to assemble, and is strong enough to restrain even larger-weight animals.

### SUMMARY OF THE INVENTION

Embodiments of the present invention may be embodied as a restraint system for an animal comprising a collar assembly and a retractable leash assembly. The collar assembly comprises a strap member adapted to be secured around a portion of the animal and a pouch member secured to the strap member. The pouch member defines a pouch chamber and an open end. The retractable leash assembly comprises a retraction assembly secured to the strap member within the pouch chamber, a cord member operatively connected to the retraction assembly, and a handle member operatively connected to the cord member. The retractable leash assembly is operable in a retracted configuration where the handle member is substantially within the pouch chamber. The retractable leash assembly is operable in an extended configuration where the handle member is outside the pouch chamber.

Embodiments of the present invention may also be embodied as a method of restraining an animal comprising the following steps. A strap member adapted to be secured around a portion of the animal is provided. A pouch member is secured to the strap member to form a collar assembly, where the pouch member defines a pouch chamber and an open end. A retraction assembly is secured to the strap member within the pouch chamber. A cord member is operatively connected to the retraction assembly. A handle member is operatively connected to the cord member. The cord member is retracted into the retraction assembly such that the handle member is substantially within the pouch chamber. The cord member is pulled from the retraction assembly so the handle member is outside the pouch chamber.

Embodiments of the present invention may also be embodied as a restraint system for an animal comprising a collar assembly and a retractable leash assembly. The collar assembly comprises a strap member adapted to be secured around a portion of the animal, a first buckle member secured relative to a first end of the strap member, an adjustment member secured relative to a second end of the strap member, a second buckle member supported by the strap member adjacent to the adjustment member, and a pouch member secured to the strap member, the pouch member defining a pouch chamber and an open end. The retractable leash assembly comprises a retraction housing secured to the strap member within the pouch chamber, a retraction member arranged within the housing, a cord member operatively connected to the retraction member, and a handle member operatively connected to the cord member. The retractable leash assembly is operable in a retracted configuration in which the handle member is substantially within the pouch chamber. The retractable leash assembly is operable in an extended configuration where the handle member is outside the pouch chamber.

It is another aspect of some embodiments of the present invention to provide a durable leash of various sizes (e.g., pocket-sized), ranging in break strength from about 80 pounds to about 130 pounds. The retractable leash of one embodiment of the present invention generally comprises a retractor assembly positioned within a pouch, which also accommodates a hand strap. However, unlike the embodiments of the present invention described above, this retractable leash is not integrated into an animal collar. The pouch of this embodiment of the present invention includes a tapered section that prevents the retractor assembly from being forcefully removed from the pouch. In operation, the user places their hand through the hand strap and holds the retractor/pouch in the palm of their hand, which situates the hand strap around the wrist. The hand strap also creates a convenient anchor to attach the pocket leash to a person or object.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a first example of a restraint system of the present invention.

FIG. 2 is a side elevation view of the first example restraint system.

FIG. 3 is a side elevation, partial cut-away view of the first example restraint system showing a leash assembly thereof in its retracted position.

FIG. 4 is a side elevation, partial cut-away view of the first example restraint system showing the leash assembly thereof in its extended position.

FIG. 5 is a top elevation, partial cut-away view of the first example restraint system showing the leash assembly thereof in its retracted position.

FIG. 6 is a top plan view of a second example of the restraint system of the present invention.

FIG. 7 is a top plan view of a third example of the restraint system of the present invention.

FIG. 8 is a perspective view of a retractable leash generally comprised of a retractor assembly situated within a pouch.

FIG. 9 is a perspective view of the embodiment of the present invention shown in FIG. 8.

FIG. 10 is a perspective view of the embodiment of the present invention shown in FIG. 8.

FIG. 11 is a side elevation view of the embodiments shown in FIG. 8, wherein a pouch tab is an open configuration, exposing an interior cavity of the pouch.

FIG. 12 is a side elevation view of the embodiments shown in FIG. 8, wherein the tab has been integrated into an opposite portion of the pouch, thereby securing and concealing the retractor assembly.

FIG. 13 is a perspective view of a retractor assembly that can be used in the embodiment shown in FIG. 8.

FIG. 14 shows the retractor assembly of FIG. 13 with a housing portion removed.

FIG. 15 is a cross-sectional view of the retractable leash shown in FIG. 8.

FIG. 16 is another cross-sectional view of the retractable leash shown in FIG. 8.

FIG. 17 is a detailed view of FIG. 16.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

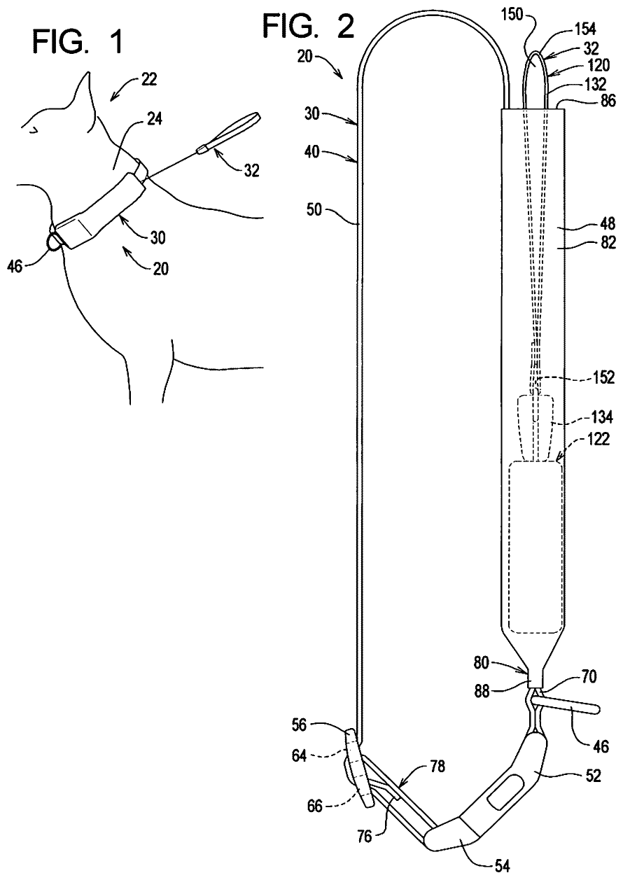

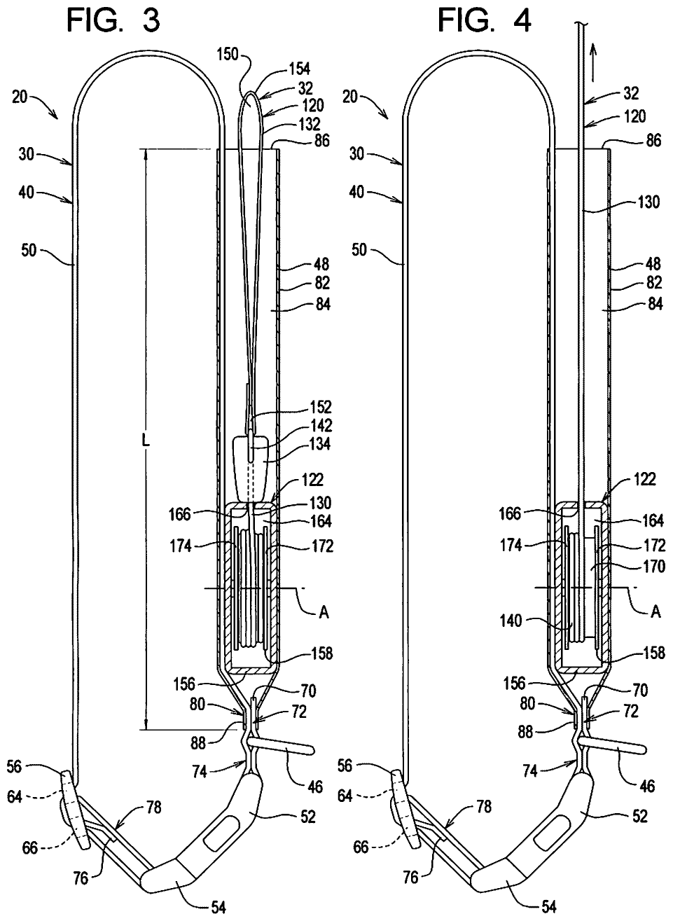

The example restraint assembly 20 comprises a collar assembly 30 and a leash assembly 32. As shown in FIG. 1, the collar assembly 30 is adapted to be detachably attached around the neck 24 of the dog 22. The example leash assembly 32 is supported by the collar assembly 30 and is reconfigurable between retracted (FIG. 3) and extended (FIG. 4) configurations.

FIG. 2 illustrates that the collar assembly 30 comprises a strap assembly 40, a ring member 46, and a pouch member 48.

The example strap assembly 40 comprises a strap member 50, a first buckle member 52, a second buckle member 54, and an adjustment member 56. The strap member 50 may be a conventional webbing material made of a material such as nylon. The first and second buckle members 52 and 54 are detachably attachable to each other to allow ends of the collar assembly to be detachably attached to each other and may be conventional. The adjustment member 56 allows an effective length of the collar assembly 30 to be adjusted and may also be conventional. The strap member 50, first and second buckle members 52 and 54, and adjustment member 56 should all be of a weight and strength sufficient as necessary for a particular size and temperament of dog.

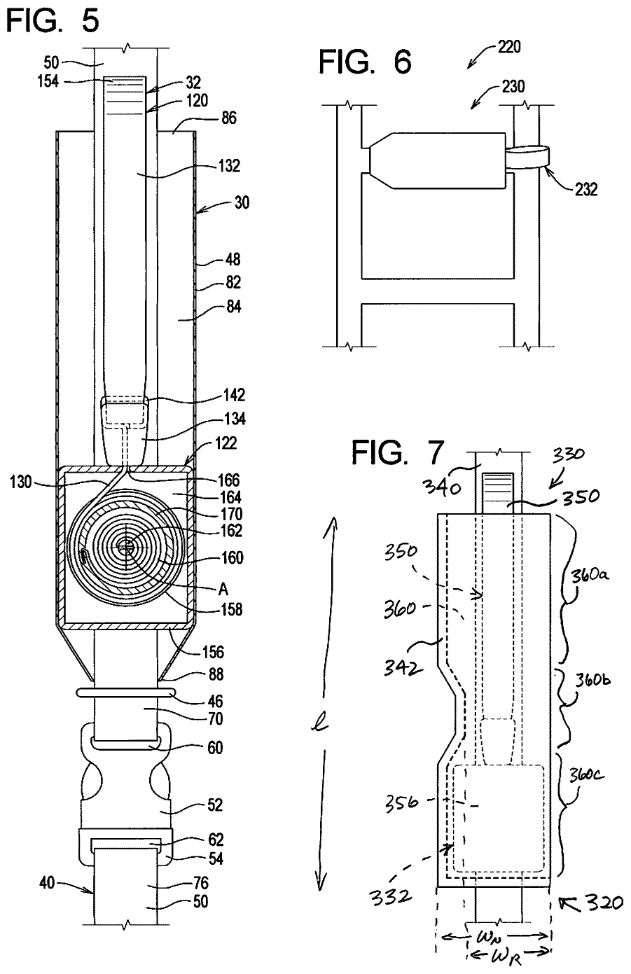

As perhaps best shown in FIG. 5, the example first buckle member 52 defines a first buckle opening 60, and the example second buckle member 54 defines a second buckle opening 62. The example adjustment member 56 defines first and second adjustment openings 64 and 66.

A first end 70 of the strap member 50 is passed through the first buckle opening 60 and attached to first and second intermediate locations 72 and 74 along the strap member 60. When the first end of the strap member 70 is attached to the first and second intermediate locations 72 and 74, the first buckle member 52 is supported in a predetermined relationship relative to the first end 70 of the strap member 50.

The ring member 46 is arranged between the first and second intermediate locations 72 and 74 when the first end 70 is attached to these locations 72 and 74. Accordingly, the ring member 46 is thus also supported in a predetermined relationship relative to the first end 70 of the strap member 60. In the example strap assembly 40, the ring member 46 is supported adjacent to the first buckle member 52.

A second end 76 of the strap member 50 is inserted through the first adjustment opening 64, through the second adjustment opening 66, through the second buckle opening 62, again through the first adjustment opening 64, and again through the second adjustment opening 66. The second end 76 is then sewn to a third intermediate location 78 along the strap member 50. The adjustment member 56 is thus supported in a predetermined relationship relative to the second end 76 of the strap member 50. However, a relationship between the second buckle member 54 and the second end 76 of the strap member 50 may be altered by sliding the adjustment member 56 relative to the strap member 50. The relationship between the strap member 50, second buckle member 54, and adjustment member 56 allows an effective length of the strap assembly 40 to be adjusted to fit the dimensions of the neck 24 of the dog 22.

The example pouch member 48 is attached to a fourth intermediate location 80 along the strap member 50. In the example strap assembly 40, the fourth intermediate location 80 overlaps the first intermediate location 72 and extends along the strap member 50 away from the first end 70 along a predetermined length L of the strap member 50. The example pouch member 48 is formed by a substantially rectangular sheet of fabric. In particular, the fabric sheet is folded and first and second opposing edges thereof are secured to the strap member 50 to form a flexible, generally cylindrical body 82 that extends along the fourth intermediate location 80 of the strap member 50. Additionally, a third edge of the fabric sheet adjacent to the first and second opposing edges is sewn to itself and to the first location of the strap member 70. The body 82 forming the pouch member 48 thus defines a pouch cavity 84 having an open end 86 and a closed end 88, with the closed end adjacent to the first buckle member 52 and the ring member 46.

As also perhaps best shown in FIGS. 4-5, the example retractable leash assembly 32 comprises a leash assembly 120 and a retraction assembly 122. The example leash assembly 120 comprises a cord member 130, a handle member 132, and a stop member 134.

The example cord member 130 is a length of material defining a proximal end 140 and a distal end 142. The material defining the cord member 130 should be capable of bearing tension loads when leading or otherwise restraining the particular dog 22 using the restraint system 20. The cord member 130 should also be of physical dimensions suitable for engaging the retraction assembly 122 as will be described in further detail below. The cord member 30 may be made of nylon, steel cable, or other material suitable for the purposes described herein.

The example handle member 132 is a loop of flexible material sewn to itself to define a handle loop 150 and a connecting loop 152. In the example leash assembly 32, the distal end 142 of the cord member 130 is inserted through the connecting loop 152 to connect the handle member 132 to the cord member 130. The handle loop 150 defines a tip portion 154.

The stop member 134 is a block of material secured to the distal end 142 of the cord member 130 adjacent to the handle member 132. The stop member 134 is sized and dimensioned and made of a material suitable for engaging the retraction assembly 122 as will be described in further detail below. The stop member 134 may also engage the cord member 130 and/or handle member 132 to form or strengthen the connection between the cord member 130 and the handle member 132.

The example retraction assembly 122 comprises a housing member 156, a spool member 158, a retraction member 160, and an anchor post 162. The housing member 156 is rigidly secured to the strap member 50 within the pouch cavity 84 adjacent to the closed end 88 thereof. The example housing member 156 may be made of a sturdy plastic material such as polyethylene terephthalate or of a fabric material such as Cordura.

The housing member 156 further defines a cord chamber 164 and a cord opening 166. The example spool member 158 defines a drum portion 170 and first and second flange portions 172 and 174. The spool member 158 is supported for rotation about an axis A within the cord chamber 164. The anchor post 162 is arranged substantially along the axis A. The example retraction member 160 is a spiral torsion spring secured at one end to the anchor post 162 and at another end to the drum portion 170 of the spool member 158. The example retraction member 160 is arranged within the drum portion 170 and around the anchor post 162.

The proximal end 140 of the cord member 130 is arranged within the cord chamber 164 and is secured to the spool member 158. When the leash assembly 32 is in the retracted configuration as shown in FIGS. 2, 3, and 5, almost the entire length of the cord member 130 is wrapped around the drum portion 170 of the spool member 158 and the retraction member 160 is slightly tensioned to maintain the cord member 130 within the cord chamber 164. When the handle member 132 is pulled, the cord member 130 unwinds from the spool member 158 such that almost the entire length of the cord member 130 is outside of the cord chamber 164; at this point, the leash assembly 32 is in the extended configuration shown in FIGS. 1 and 4.

When the leash assembly 32 is in the extended configuration, the tension on the retraction member 160 is increased. Accordingly, releasing pressure on the handle member 132 allows the retraction member 160 to rotate the spool member 158 and thereby wind the cord member 130 back onto the spool member 158. The side flanges 172 and 174 of the spool member 158 direct the cord member 130 onto the drum portion 170 thereof as the cord member 130 is wound back onto the spool member 158.

To prevent the retraction member 160 from constantly shortening the length of the cord member 130 outside of the housing 156, a locking system may be provided. The locking system may be a buckle engagement clip, a catch and release toggle, or a spring-loaded release toggle. The example retraction assembly 122 comprises a release toggle capable of remaining in at least first and second positions. In the first position, the toggle is flush with the end of the lock and the cord member 130 cannot move. In the first position, the toggle is not flush with the end of the lock, allowing the cord member 130 to move.

The stop member 134 engages the housing member 156 when the cord member 130 is fully retracted. The retraction member 160 can retract the cord member 130 fairly quickly, and the stop member 134 is typically rigid or can be made of a flexible material that can absorb shocks that would otherwise be transmitted to the juncture of the cord member 130 and the handle member 132.

FIGS. 3 and 5 further show that, when the leash assembly 32 is in the retracted configuration, the handle member 132 is substantially arranged within the pouch cavity 84. In the example leash assembly 32, the tip portion 154 of the handle member 132 extends outside the pouch cavity 84 to facilitate gripping of the handle member 132 to place the leash assembly 32 back into the extended configuration. Alternatively, the entire handle member 132 may be configured to be within the pouch cavity 84 when the leash assembly 32 is in the retracted configuration, in which case the pouch member 48 may be provided with a seam to facilitate access to the pouch cavity 84 and thus the handle member 132 when required. If such a seam is provided, a fastening system such as a zipper or hook and loop fastener may be provided to hold the seam closed when access to the pouch cavity 84 is not required.

Referring now to FIG. 6 of the drawing, depicted therein is a second example restraint assembly 220 constructed in accordance with, and embodying, the principles of embodiments of the present invention.

Like the first example restraint assembly 20, second example restraint assembly 220 comprises a collar assembly 230 and a leash assembly 232. The second example leash assembly 232 is or may be the same as the first example leash assembly 32 described above and is similarly reconfigurable between retracted and extended configurations.

The example restraint assembly 220 is intended for use with pets where use of a collar system like the collar assembly 30 is not appropriate. For example, the second example collar assembly 230 may be sized and dimensioned to be detachably attached around the neck and chest of a smaller animal such as a cat in a conventional manner. Alternatively, the second example collar assembly 230 may be sized and dimensioned for larger or difficult to control animals that require straps around both the neck and the chest.

Referring now to FIG. 7 of the drawing, depicted therein is a third example restraint assembly 320 constructed in accordance with, and embodying, the principles of embodiments of the present invention.

Like the first example restraint assembly 20, second example restraint assembly 320 comprises a collar assembly 330 and a retractable leash assembly 332. The second example retractable leash assembly 332 is or may be the same as the first example retractable leash assembly 32 described above and is similarly reconfigurable between retracted and extended configurations.

Like the collar member 30 described above, the collar assembly 330 comprises a strap assembly 340, a ring member (not shown), and a pouch member 342. The retractable leash assembly 332 comprises a leash assembly 350 having a handle portion 352 and a retraction assembly 354 having a housing 356.

The example pouch member 342 has a length dimension L and a nominal width dimension Wx. The pouch member 342 has a restriction width dimension WR. The restriction width dimension WR is smaller than the nominal width dimension Wx so that an interior chamber 360 defined by the pouch member 342 has an inlet portion 360a, an intermediate portion 360b, and a storage portion 360c.

The storage portion 360c is sized and dimensioned to receive the housing 356 of the retraction assembly 354, while the handle portion 352 of the leash assembly 350 is slightly longer than the total lengths of the inlet portion 360a and intermediate portion 360 b of the pouch chamber 360. In addition, the inlet portion 360a and intermediate portion 360 b are sized and dimensioned to receive the handle portion 352 of the leash assembly 350, but the intermediate portion 360b of the pouch chamber 360 is too small to allow the housing 356 of the retraction assembly 354 to pass from the storage portion 360c to the inlet portion 360b.

Accordingly, the narrowed intermediate portion 360b of the pouch chamber 360 secures the housing 356 within the storage portion 360c of the pouch chamber 360. The shape of the pouch member 342 thus can obviate the need to provide an additional fastener for connecting the housing 356 to the collar assembly 330. In this embodiment, the housing 356 will be arranged to be within the storage portion 360c when the pouch member 342 is formed.

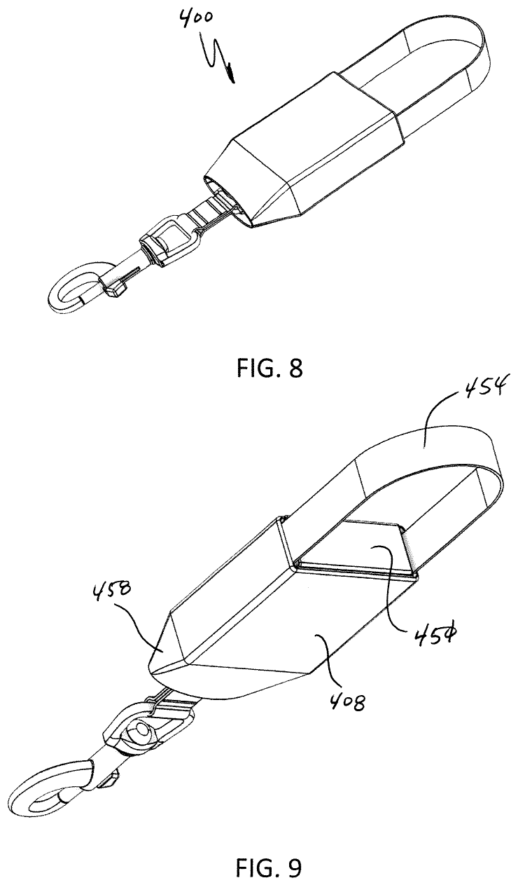

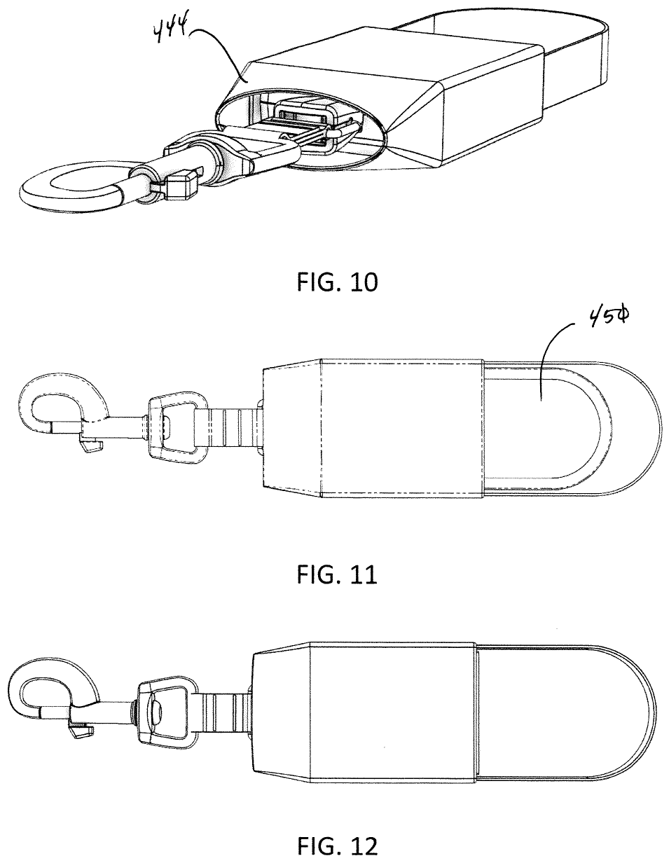

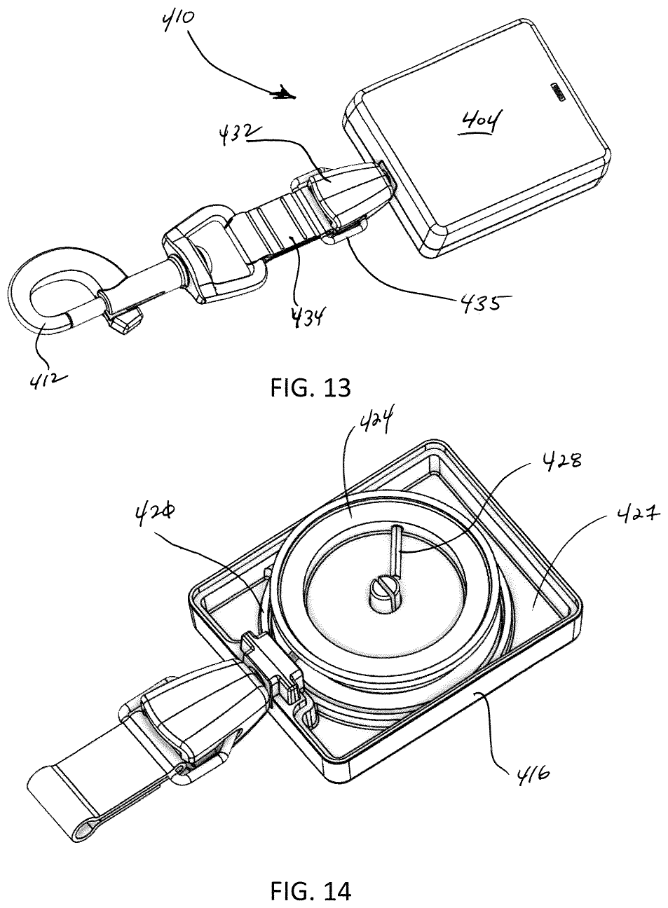

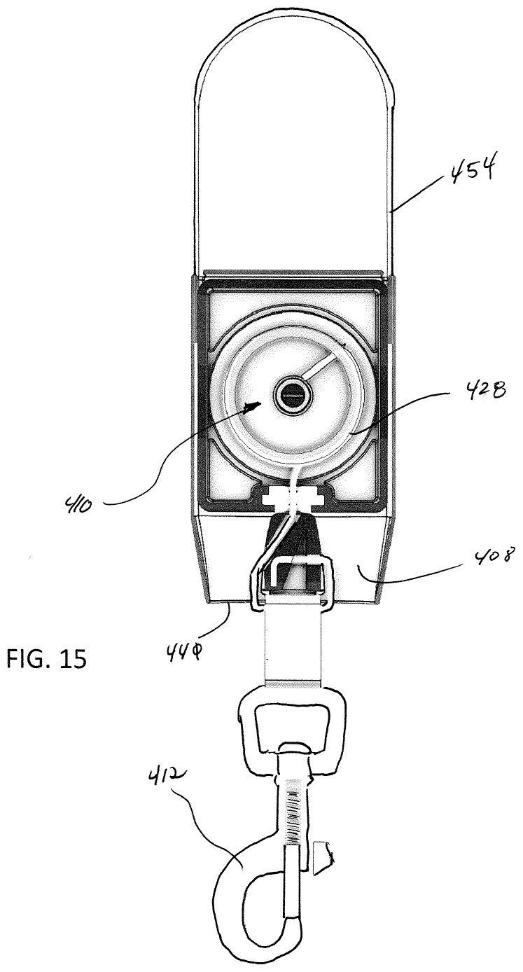

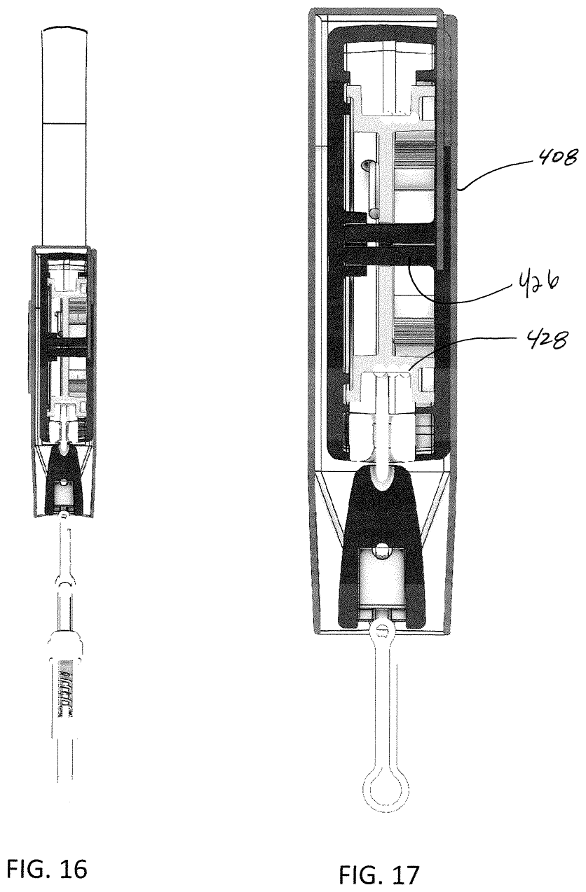

FIGS. 8-17 show another embodiment of a retractable leash 400 similar to that of FIGS. 6 and 7, wherein a retractor 404 is situated within a pouch 408. Here, however, the retractor 404 is associated with a hook 412 configured to selectively interconnect to a pet collar or harness. The retractor assembly 410 comprises a housing 416 that accommodates a cord 420 selectively wrapped about a spool 424 that is supported by a hub 426 that extends from an inner surface 427 of the housing. The spool 424 is rotationally biased by a spring 428 and, thus, will urge a stop member 432 towards the housing 416 when tension is removed from the hook 412. As shown, the stop member 432 is interconnected to the hook 412 by a strap 434 by way of a ring 435.

Again, the primary difference between this embodiment and the other embodiments described herein is that the cord 420 is associated with the hook, not the strap the user grasps. Accordingly, the pouch is smaller, and the strap is not configured to be selectively concealed within the pouch. Finally, an opening 440 in the pouch possesses an outer extent that is less than the outer extent of the pouch, thereby creating a restriction 444 that prevents the retractor assembly from being removed from the pouch. Thus, assembly of the retractable leash comprises placing the retractor assembly into the pouch with the hook 412 extending from the opening 440 and sealing the pouch by folding a tab portion 450 thereof over an opening adjacent to the strap 454 that the user grasps. In operation, the force generated by cord retraction is reacted by pouch sidewalls 458 that are partially defined by the aforementioned restriction.

Again, the mechanisms and materials of manufacture of this embodiment of the present invention can be the same or similar to that of the other embodiments described herein.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A restraint system for an animal comprising:
a retractor assembly comprising:
a housing;
a retractor accommodating a spring-biased spool rotatably interconnected to a hub associated with an inner surface of the housing;
a cord member interconnected to the spool; and
a stop member interconnected to an end of the cord member;
a hook associated with the stop member;
a pouch having a first open end, a second open end, which has an outer extent that is less than an outer extent of the first open end, and a tab member associated with the first open end;
wherein when the retractor assembly is placed within the pouch, the hook is capable of selective extension from the retractor assembly and but the retractor assembly is prevented from exiting the pouch through the second opening; and
wherein the retractor assembly is also prevented from exiting the pouch through the first opening by the tab member.

2. The restraint system of claim 1, wherein an effective length of the restraint system is adjustable.

3. The restraint system of claim 1, further comprising a strap interconnected to the pouch near the first opening.

4. The restraint system of claim 1, wherein the cord is withdrawn from the retractor assembly by application of manual force.

5. The restraint system as recited in claim 1, further comprising a locking mechanism for releaseably locking the cord in an extended configuration.

6. A restraint system for an animal comprising:
a retractor assembly comprising:
a housing;
a cord retractor;
a cord member operatively interconnected to the cord retractor; and
a hook associated with an end of the cord;
a pouch having a first open end, a second open end, which has an outer extent that is less than an outer extent of the first open end, and a tab member associated with the first open end;
wherein when the retractor assembly is placed within the pouch, the hook is capable of selective extension from the cord retractor and but the cord retractor is prevented from exiting the pouch through the second opening; and
wherein the retractor assembly is also prevented from exiting the pouch through the first opening by the tab member.

7. The restraint system of claim 6, wherein an effective length of the cord member is adjustable.

8. The restraint system of claim 6, further comprising a strap interconnected to the pouch near the first opening.

9. The restraint system of claim 6, wherein the cord is withdrawn from the cord retractor by application of manual force.

10. The restraint system as recited in claim 6, further comprising a locking mechanism for releaseably locking the cord in an extended configuration.
